(19) United States
(12) Patent Application Publication
(10) Pub. No.: US 2007/0185275 A1
(43) Pub. Date: Aug. 9, 2007

(54) Chemical composition and method of polymerisation thereof for use on vehicle bodywork repair

(75) Inventor: Paolo Molendi, Reggio Emilia (IT)

Correspondence Address: HOGAN & HARTSON LLP;IP GROUP, COLUMBIA SQUARE, 555 THIRTEENTH STREET, N.W., WASHINGTON, DC, 20004, US

(73) Assignee: INDUSTRIA CHIMICA REGGIANA I.C.R. S.p.A.

(21) Appl. No.: 10/567,853

(22) PCT Filed: Aug. 11, 2003
(86) PCT No.: PCT/IT03/00507

§ 371 Date: Jul. 28, 2006

(51) Int. Cl. C08F 287/00

(52) U.S. Cl. 525/245

(57) ABSTRACT

The present invention relates to a chemical composition and a method of polymerisation of said composition useful in the vehicle bodywork repair sector. Said chemical compositions comprises 10% to 60% of synthetic resins, 10% to 70% of monomers selected from oligoethers and acrylate or methacrylate monomers, 0% to 90% of solvents and 0.1% to 10% of photoinitiators which initiate the polymerisation process when stimulated by light radiation.

### FIELD OF INVENTION

The present invention relates to a chemical composition and a polymerisation method for said composition, and relates in particular to a composition and a method useful in the vehicle bodywork repair sector.

### BACKGROUND OF THE INVENTION

Vehicle bodywork repairs are currently carried out in various stages which usually comprise, in sequence, the reshaping or the replacement of the damaged parts, the filling and later sandpapering, the application of one or more primer(s) and relevant polymerisation(s), the preparation of the surfaces for varnishing using abrasive papers, the application of a “base coat” and the drying thereof at room temperature, the application of a “clear coat 2K” and the polymerisation thereof through a cooking cycle in an oven at 60° C. for 30-60′ or at room temperature for approx. 24 hours. Lastly, a final stage can be carried out comprising the elimination of any possible defects arising from the previous stages and, in the case of work on limited areas of bodywork (retouching), polishing with abrasive (cutting) paste and polish in order to blend in the repaired and revarnished parts with these not affected by the retouching.

In particular, by the term “primer” is meant any type of varnish used in the sector which has the function of preparing the metal bodywork panel for the adhesion of new original varnish to said bodywork panel, and for the protection thereof.

By the term “base coat” is meant a metalicised, micalized or coloured varnish having a colouring function which restores the colour of the original bodywork where it has been damaged.

By the term “clear coat 2K” is meant a transparent varnish consisting of a polymerisable component and a catalyst essential for said polymerisation.

Bodywork repairs for vehicles, or parts thereof, according to the above-mentioned procedure have some inconveniences. Firstly, the polymerisation execution times for the oven cooking of the “clear coat 2K” are particularly long. Furthermore, prior to being able to carry out the final stage of the elimination of any possible defects, the “clear coat 2K” requires to be perfectly polymerised otherwise it is impossible to carry out the polishing of the treated area. Polymerisation by heating in an oven however, is not usually prolonged for more than 20-35′ due to the high costs of the fuels used, whereby, the degree of polymerisation obtained in this stage is never complete. This implies however that the treated part must be left in order to complete polymerisation for even 24 hours, with a significant delay for the finishing stage. It is understood that these times have repercussions on the delivery of the repaired vehicle with high costs which must be supported by the owner.

### SUMMARY OF THE INVENTION

The problem at the heart of the present invention is therefore that of providing a vehicle bodywork repair method which is rapid, reliable and economically advantageous, both for the repairer and for the owner of the repaired vehicle.

This problem is solved by a method as covered by the attached claims.

Accordingly, the first aim of the present invention is to provide a transparent polymerisable chemical composition which is particularly useful in the vehicle bodywork repair sector.

A second aim of the invention is a process for the preparation of said chemical composition.

A further aim is a polymerisation method for said chemical composition.

A still further aim is the use of a polymerisable chemical composition for the repair of the bodywork of vehicles or parts thereof.

Further characteristics and the advantages of the present invention will be more understood from the following description of an example embodiment given for non limiting indicative purposes.

### DETAILED DESCRIPTION OF THE INVENTION

The transparent polymerisable chemical composition of the invention can be advantageously used for applications in the sector of repairs to the bodywork of vehicles or parts thereof. This composition comprises 10% to 60% of transparent hydroxylated acrylic resins, 10% to 70% of oligoethers and monomers selected from acrylates or methacrylates, 0% to 90% of solvents and 0.1% to 10% of photoinitiators which initiate the polymerisation process when stimulated by light radiation.

In particular, the composition comprises 20% to 50% of resin, 20% to 70% of monomers, 5% to 50% of solvents and 0.5% to 6% of photoinitiators.

Preferably, the transparent resins are selected from the group constituted by acrylic, polyester acrylate, urethane acrylate aromatic or aliphatic resins or mixtures thereof. Furthermore, the resins which have proved to be particularly suitable were the resins with carboxylic functionality from 1 to 6 (declared and calculated according to the manufacturer) and, more preferably, the resins with functionality comprised of between 2 and 6.

The monomers and methacrylic oligoethers are selected from the group consisting of Isobomyl methacrylate (IBOMA), Tetraethyleneglycol dimethacrylate (TTEGDMA), whilst the oligoethers and acrylate monomers are selected from Isobomyl acrylate (IBOA), 1,6 Hexanediol diacrylate (HDDA), Trimethylolpropane triacrylate (TMPTA), Tris(2-Hydroxyethyl) isocyanurate triacrylate (THEICTA), Tricyclodecane dimethanol diacrylate (TCDDMDA). Preferably, said monomers have functionality comprised of between 1 and 5. More preferably, said monomers and oligoethers are represented by Tris(2-Hydroxyethyl) isocyanurate triacrylate (THEICTA), Tricyclodecane dimethanol diacrylate (TCDDMDA) and, in addition N-vinyl-2-pyrrolidone.

The solvents used in the composition herein are represented by the standard solvents normally added to varnishes such as, for example, esters, ketones or aromatic hydrocarbons. Amongst the esters methyl acetate and ethyl acetate can be used, amongst the ketones acetone and methyl ethyl ketone can be used, whilst amongst the aromatic hydrocarbons toluol can be used.

The photoinitiators, as mentioned above, are substances capable of initiating the polymerisation process of the chemical composition when they are subjected to light radiation. In particular, the photoinitiators according to the invention can be activated by various light sources such as solar or artificial light, preferably UV irradiation. In particular, the products which proved to be the best have been those which initiate polymerisation following exposure to UV-A type irradiation, or rather benzophenone derivatives amongst which the preferred are 4 methylbenzophenone and 2,4,6-trimethylbenzophenone, ketone derivatives, amongst which are 1-hydroxy-cyclohexyl-phenyl-ketone, 2,2-dimethoxy-1,2-diphenylethan-1-one, 2-hydroxy-2-methyl-1-phenyl-propan-1-one, methyl esters amongst which are the methyl ester of phenyl glyoxylic acid and phosphinoxides amongst which are the oxide of 2,4,6-trimethylbenzoyl-diphenyl-phosphine, or mixtures thereof.

The above mentioned chemical composition can fuirthermore comprise additives, of the types widely known in the sector, having antioxidant functions which confer heat stability, such as for example the product IRGANOX 1010 pentaerythritol (tetrakis(3-(3,5-di-tert-butyl-4-hydroxyphenyl)propionate)) sold by CIBA. A product which performs a protective role on the “clear coat” composition when it is exposed to sunlight can also be used. Amongst the products available on the market, in particular the derivative of hydroxyphenyltriazine into 1-methoxy-2-propanol TINUVIN 400, as sold by CIBA can be used. Moreover, a product which confers a hydrorepellant effect which increases surface slipperiness can be used. Chemically, this product is a silicone graft polymer which polymerises together with the other resins of the composition through radiation. An example of said product available on the market is BYK UV 3500 as sold by BYK.

The additives can be present in amounts ranging from 0% to 10%, preferably from 0.1% to 3%.

The chemical composition just described can be produced according to a method which in general envisages the following sequential stages of:
a) preparing a solution comprising at least one resin amongst these listed above and a suitable solvent or monomer;

b) slowly stirring the solution for a time comprised of between 1′ and 20′ at a temperature comprised of between 58° C. and 70° C.;

c) adding to the solution at least one photoinitiator from amongst those listed above following solubilisation in a suitable solvent;
d) mixing for a time comprised of between 5 and 20 minutes so as to obtain a homogeneous solution and taking care to keep the solution protected from solar or artificial light.

In particular, stage a) is prepared with a solution comprising 10 to 60 parts resins and 40 to 90 parts solvents or monomers. When more resins are used, the solution can be prepared by mixing 10 to 70 parts resins with 30-80 parts monomers or solvents, heating to 58-70° C., with slow stirring, until obtaining a transparent solution, in a container made from AISI 304.

In stage c), the photoinitiators, previously solubilised in solvents at 40-60%, are added to the solution to a final percentage of 1-6%.

According to an additional aspect of the present invention, the above chemical composition can be polymerised according to a method which comprises exposure of the composition to UV type radiation.

In fact, it has been surprisingly found that if the subject chemical composition is subjected to UV radiation, the polymerisation process thereof is speeded up incredibly.

The polymerisation by UV can be made by using various types of lamps such as high power and high pressure lamps which emit UV radiation in the B and part of the C ranges. However, these types of lamps are dangerous and their use requires an environment suitable to safeguard the operator from the dangerous types of radiation.

Preferably, therefore, lamps which emit type A UV radiation and, more precisely, lamps which emit radiation between 280 and 450 nm are used, which are extremely safer than those above. The lamps are of the fluorescence or metallic iodide-type. Alternatively, lamps which also emit in the UV-B and UV-C regions can be used, but provided with special filters for the neutralisation of the B and C type radiation.

In general, for static applications, i.e. when the lamp is attached onto a suitable support, lamps with power ratings comprised of between 100 W and 5 KW or multi-lamp systems with power outputs varying between 200 W up to 5 KW per lamp unit can be used, even using more units. More particularly, the lamp power outputs can vary from 0.1 W/cm² to 20 W/cm² of irradiated surface.

The exposure times depend on the “clear coat” thicknesses applied, the distance and the power output of the lamp used. In general, exposures vary from 5 seconds to 15 minutes. For dry thicknesses of around 40-60 microns normally applied in car bodywork repair operations, the exposure times can be considered to be independent from the thicknesses. Since the UV photopolymerisation is a function of the power output per unit of surface area W/cm², by increasing the distance of the lamp, the lamp floodlight will irradiate a greater surface area reducing the power in Watts per unit of surface area. For example, by placing a 400 Watt lamp at a distance of between 15 and 20 cm from the surface to be irradiated, around 600 cm² will be irradiated with a power of approx. 0.7 W/cm² for such a period of time necessary as to obtain good polymerisafion comprised of between 2 and 4 minutes. By using a lamp with a power output of 5,000 Watts placed at a distance of between 20-25 cm from the surface to be irradiated, 1,200-1,500 cm² are irradiated with a power output respectively comprised of between 4 W/cm² and 3 W/cm² and a time comprised of between 50 and 30 seconds. Such times are obviously inversely proportional to the power output per unit surface area irradiated by the UV lamp.

For small repairs, i.e. repairs which affect a surface area of from 600 cm² to 6,000 cm², the lamp(s) are positioned on an appropriate fixed support, of a known type, which can allow the rapid positioning at the level of the surface to be treated. In the case in which the polymerisation must affect a more enlarged surface or even the entire vehicle bodywork, it is possible to mount the lamps onto robotised rigs which are able to homogeneously irradiate complex profile surfaces by performing a scan of the surface to be irradiated with a scanning speed directly proportional to the power output of the UV system used. In this case, it is preferable to use lamps with power outputs varying between 2.5 KW to 25 KW.

According to a further aim of the invention, in the following will be described a treatment method for vehicle bodywork surfaces or parts thereof with the above mentioned (“clear coat”) chemical composition.

The treatment method comprises the following sequential stages of:
i) providing a polymerisable chemical composition comprising 10% to 60% of transparent hydroxylated acrylic resins, 10% to 70% of monomers selected from oligoethers and acrylate or methacrylate monomers, 0% to 90% of solvents and from 0.1% to 10% of photoinitiators;
ii) applying a layer of said chemical composition onto the surface to be treated;
iii) leaving the solvent contained in said layer of said chemical composition to evaporate;
iv) irradiating said layer with a UV irradiation lamp for a time sufficient as to substantially obtain the complete polymerisation thereof.

The polymerisable chemical composition is preferably the composition described above.

The application stage ii) of a layer of said composition preferably occurs through the deposition in the form of a film previously diluted with an appropriate solvent, such as these previously described. The film which is deposited has a thickness which can vary from 10 microns to 100 microns and its viscosity can vary from 12 to 18 seconds in a Ford #4 cup (according to the ASTM system) and according to the degree of dilution adopted.

The evaporation stage iii) of the solvent will depend on the conditions adopted from time to time i.e. the thickness of the deposited film, the amount of solvent used and the chemical composition used. In any case, in general, the evaporation time (“flash off”) varies from 1 minute to 5 minutes.

The irradiation stage iv) of said layer can occur according to the previously described polymerisation process.

In addition, the treatment method comprises the following steps prior to the application of the polymerisable chemical composition:
the reshaping or replacement of the damaged bodywork parts;
the filling and sandpapering of the surface of said damaged parts;
the application of one or more primers onto said surface and the relative polymerisation;
the preparation of said surface for the application of the “base coat” using abrasive papers;
the application of the “base coat”.

The steps just described are entirely conventional in the vehicle bodywork repair sector whereby they will not be described in any further detail.

Finally, the treatment method can provide a last stage consisting of finishing, i.e. the elimination of any possible defects arising during the execution of the preceding stages, in agreement with known techniques.

From what stated up to now, numerous advantages brought about by the polymerisable chemical composition, the polymerisation procedure thereof as well as the treatment method for the bodywork of vehicles or parts thereof with said composition are evident.

Firstly, the chemical composition of the invention does not require any catalyst to activate the polymerisation process. This means that even the loss of time, due to the time required for the mixing of the two components, necessary in the case of the use of the above mentioned “clear coat 2K”, is avoided. Consequently, the preparation of the polymerisable chemical composition according to the invention is simpler to carry out and allows a substantial saving in production costs.

Secondly, the polymerisation stage of the polymerisable chemical composition (“clear coat”) on average is completed within 5-7 minutes, whilst the subsequent optional finishing stage can be accomplished after a few minutes. On the contrary, as previously reported, according to the known art, said stage requires oven cooking times comprised of between 30 and 60 minutes or 24 hours at room temperature. Therefore, the time saving which the composition of the invention brings about is incredible.

In addition, the above mentioned polymerisation is very rapid and the manufacturing costs are very low with respect to these which must be faced with the oven cooking method, as explained in the introductory section of the present description. In fact, the use of UV lamps for a few minutes for the polymerisation is much more economical and faster than the use of high temperature ovens which work through the combustion of very expensive fuels.

Surprisingly, it has also been observed that the polymerisation with UV enables the attainment of polymerisation percentages close to 100% in very short times, as will be apparent from the comparative test reported below. From that it arises that even the finishing can be made with great ease and rapidity and however with optimal results.

In the following are reported some example embodiments, given as non limiting indications of the invention.

### EXAMPLE 1

### Preparation of the (Transparent) “Clear Coat” Polymerisable Chemical Composition

12.32 g of tris (2-hydroxyethyl) isocyanurate triacrylate, produced by Cray Valley and sold under the commercial name Sartomer SR 368, and 35.46 g of methanol diacrylate tricyclodecane, produced by Cray Valley and marketed under the name of Sartomer SR 833S are weighed in an AISI 304 steel basin and heated to 58° C. They are slowly stirred until complete solution is obtained. Afterwards, 25.46 g of hydroxylated acrylic polyol with 1-2% of OH with reference to the dry weight of the resin are added. This product is available on the market from various manufacturers, as 50% of the dry resin in butyl acetate, such as Desmophen A450 from Bayer, Setalux 1184 SS-51 from AKZO RESINS, Domacryl 546 from HELIOS. In the present example Setalux 1184 SS-51 has been used. 14.01 g of N-vinyl-2-pyrrolidone produced by BASF are also added along with the additives TINUVIN 400 at 50% in ethyl acetate in an amount of 0.6 g, IRGANOX 1010 at 20% in ethyl acetate in an amount of 1.5 g and BYK UV 3500 in an amount of 0.4 g. Slow stirring takes place for 15 minutes. Later, the following amounts of photoinitiators, previously solubilised in 6 g of cyclohexanone, are added:
0.7 g of IRGACURE 184;
3.2 g of DAROCUR TPO;
0.35 g of DAROCUR MBF.

The resulting product is mixed for 10 minutes so as to obtain homogeneity of the composition, taking care to keep the product from exposure to solar or artificial light thereby avoiding the danger of polymerisation. At this point the polymerisable chemical composition is stored in screw topped metallic containers and maintained at room temperature.

### EXAMPLE 2

### Polvmerisation Procedure of the Polymerisable Chemical Composition

A steel panel according to European standard ISO 1514 has been employed as a sample in order to evaluate the polymerisation of the composition of the invention. Onto the surface of said panel has been applied an acrylic primer constituted by “Acrylic Primer F51 2K” catalysed in the ratio of 5:1 with “C16 Universal Catalyst” both produced by ICR Spa. Following 24 hours of polymerisation at room temperature, the panel has been dry sanded with abrasive papers of decreasing grain from P150 to P600, manufactured by 3M. Afterwards, the surface of the panel thus treated has been covered with a 20 micron layer of BASISLACK type metalicised “base coat” as sold by STANDOX, diluted to 60% with “11040” the specific diluent for metalicised paints. The “base coat” has been left to air dry at room temperature for 3 minutes. At this point, onto the dried “base coat” has been applied a layer of approx. 50 microns of the composition of example 1 (“clear coat”) following dilution with ethyl acetate so as to obtain a viscosity of 15″ in a Ford #4 cup. After three minutes from said application, so as to allow the evaporation of the solvent, the panel has been irradiated for 2 minutes with an OSRAM Ultramed lamp with a power output of 400 W placed at a distance of 20 cm from the surface treated with the above mentioned composition.

### EXAMPLE 3

### Comparative Application Test of the Polymerisable Chemical Composition According to the Invention with Respect to a Composition of the Known Art

In order to test the effectiveness of the polymerisable chemical composition of example 1, six steel panels according to the European standard ISO 1514 have been prepared. A primer as described in example 2 has been applied onto all the panels and the same procedure has been followed up to the application of the “base coat”. Afterwards, the test surfaces on 4 of the six panels have been covered with approx. 50 microns of “H61 Transparent Acrylic 2K” type “clear coat 2K” as sold by ICR Spa, catalysed by an aliphatic isocyanate based catalyst “Universal Catalyst C15” as produced by ICR Spa, in a ratio of 2:1 and diluted with 25% of polyurethane diluent “Diluent D10” (again from ICR Spa) so as to obtain an application viscosity of 18″ in a Ford #4 cup. Two panels have been subjected to a cooking cycle in an oven for 30 minutes at 60° C., whilst another two have been kept at a temperature of around 20° C. for a total time of 7 days. Instead, the remaining two panels have been treated in agreement with example 1 and example 2.

Hardness tests carried out 10 minutes after the end of the polymerisation cycle, by leaving the panels at room temperature have given the following results reported in table I. For the hardness tests, the Persoz method has been used at room temperature.

TABLE I

| | | | Resting time | |
|---|---|---|---|---|
| | | | following | |
| | Polymerisation | Polymerisation | polymerisation | |
| | time (minutes/ | temperature | (minutes/ | |
| Product | hours/days) | (° C.) | hours/days) | hardness |
| Clear coat | 30′ | 60° | 10 minutes | 180″ |
| 2k | | | | |
| Clear coat | 30′ | 60° | 4 hours | 190″ |
| 2k | | | | |
| Clear coat | 30′ | 60° | 24 hours | 285″ |
| 2k | | | | |
| Clear coat | 30′ | 60° | 7 days | 330″ |
| 2k | | | | |
| Clear coat | 4 hours | 20° | — | 70″ |
| 2k | | | | |
| Clear coat | 24 hours | 20° | — | 245″ |
| 2k | | | | |
| Clear coat | 7 days | 20° | | 320″ |
| 2k | | | | |
| Clear | 2′ under the | — | 10′ | 340″ |
| coat UV | conditions of | | | |
| | example 1 | | | |
| Clear | 2′ under the | — | 24 hours | 352″ |
| coat UV | conditions of | | | |
| | example 1 | | | |
| Clear | 2′ under the | — | 7 days | 355″ |
| coat UV | conditions of | | | |
| | example 1 | | | |

The hardness values reported in table I clearly indicate that finishing operations such as polishing can be quickly carried out on the “clear coat UV” layer applied according to the present invention, whilst that is not possible in the case the “clear coat 2K” of the known art is used since the surface is not sufficiently hardened. In fact, sufficient hardness in order to allow such operations with the known art is obtained only after at least 4 hours from the end of the oven cooking cycle at 60° C. In any case, it is to be noted that optimal hardness (280-300″ Persoz) is obtained only after at least 24 hours.

### EXAMPLE 4

### Adhesion Test

On the panels subjected to the Persoz hardness test, adhesion tests have been carried out according to European standard ISO 4624. The adhesion of the chemical composition of the invention onto the “base coat” has been close to 100%.

### EXAMPLE 5

### Application Test

The polymerisable chemical composition of example 1 has been applied onto parts of the bodywork of vehicles in order to evaluate the application characteristics. The applications have affected different sections of the bodywork over areas of approx. 20×20 cm and in every case a surface deformation has been caused by hitting the bodywork with a hammer. Later, the deformed part has been filled with “S01 UV Monocomponent polyester filler” filler produced by ICR Spa and sanded with P150 abrasive paper from 3M. Later, an “F01 Filling Primer UV” type primer produced by ICR Spa has been applied. The application of the “base coat” was then performed as described above. Afterwards, the procedure of example 1 has been carried out by first applying a 70-80 micron layer of the chemical composition diluted to 50% with ethyl acetate. The same chemical composition has then been diluted again with 25% ethyl acetate and has been applied by spraying, with a specific conventional spray gun, taking care to widen out over the original varnish. Following three minutes of rest in order to allow for the evaporation of the solvent, the surface thus treated has been irradiated for 2 minutes under the conditions described in example 3. Once the treated bodywork part has reached room temperature (approx. 10 minutes), the surface has been blended in with the non treated surface by finishing (polishing) with abrasive (cutting) paste and polish.

The various tests carried out on the different “base coats”, even with very clear or dark colours, have given a very valid result to such an extent that the treated parts were no longer distinguishable from the originals.

In addition, tests have also been carried out on surfaces which had not been prepared with abrasives, or polished. Nevertheless, optimal adhesion in obtaining approx. 100% has been found.

The polymerisable chemical composition, the relevant polymerisation procedure as well as the treatment method for bodywork or parts of them allow therefore the solution of the inconveniences caused by the use of the compositions and the methods of the known art, described in the introductory section of the present description, and provide numerous, already described, advantages.

Variant embodiments of the polymerisable chemical composition, of the relevant polymerisation procedure as well as the treatment method of bodywork or parts of them according to the invention are within the range of the expert in the sector and however fall within the protection scope of the following claims.

1. A transparent, polymerisable chemical composition comprising 10% to 60% of transparent hydroxylated acrylic resins, 10% to 70% of monomers selected from oligoethers and acrylate or methacrylate monomers, 0% to 90% of solvents and 0.1% to 10% of photoinitiators which initiate the polymerisation procedure when stimulated by light radiation.

2. The composition according to claim 1, comprising 20% to 50% resin, 20% to 70% monomers, 5% to 50% solvents and 0.5% to 6% photoinitiators.

3. The composition according to claim 1, wherein said resins are selected from the group consisting of acrylic, polyester acrylate, urethane acrylate aromatic or aliphatic resins or mixtures thereof.

4. The composition according to claim 1, wherein said resins have carboxylic functionality of between 1 to 6, preferably comprised of between 2 and 6.

5. The composition according to claim 1, wherein said methacrylate monomers and oligoethers are selected from the group consisting of Isobomyl methacrylate(IBOMA), Tetraethyleneglycol dimethacrylate (TTEGDMA), and combinations thereof, whilst the acrylate oligoethers and monomers are selected from the group consisting of Isobornyl diacrylate (IBOA), 1,6 Hexanediol acrylate(HDDA), Trimethylolpropane triacrylate (TMPTA), Tris(2-Hydroxyethyl)isocyanurate triacrylate (THEICTA), Tricyclodecane dimethanol diacrylate (TCDDMDA), and combinations thereof.

6. The composition according to claim 5, wherein said monomers have functionality comprised of between 1 and 5.

7. The composition according to claim 5, wherein said monomers comprise N-vinyl-2-pyrrolidone.

8. The composition according to claim 1, wherein said solvents are selected from the group consisting of esters, ketones or aromatic hydrocarbons normally used in the varnishes sector, and combinations thereof.

9. The chemical composition according to claim 1, wherein said photoinitiators are selected from the group consisting of benzophenone derivatives, ketone derivatives, methyl esters and phosphinoxides, or mixtures thereof.

10. The composition according to claim 9, wherein said benzophenone derivatives are selected from the group consisting of 4 methylbenzophenone and 2,4,6-trimethylbenzophenone and combinations thereof, said ketone derivatives are selected from the group conisting of 1-hydroxy-cyclohexyl-phenyl-ketone, 2,2-dimethoxy-1,2-diphenylethan-1-one, 2-hydroxy-2-methyl-1-phenyl-propan-1-one and combinations thereof, said methyl esters are phenyl glyoxylic acid and said phosphinoxides are 2,4,6-trimethylbenzoyl-diphenyl-phosphine oxide.

11. The composition according to claim 1, a further comprising additives in quantities from 0% to 10%.

12. The composition according to claim 11, wherein said additives are antioxidants, protectives against solar radiation or products which confer hydro-repellance.

13. The composition according to claim 12, wherein said antioxidants are IRGANOX 1010, said protectives are TINUVIN 400, said products conferring hydro-repellance are BYK UV 3500.

14. A method for the preparation of the chemical composition according to claim 1, comprising the steps of:
a) preparing a solution by adding at least one resin and a suitable solvent or monomer;
b) stirring the solution slowly for a time comprised of between 1′ and 20′ at a temperature comprised of between 58° C. and 70° C.;
c) adding at least one photoinitiator, to the solution following solubilisation in a suitable solvent;
d) mixing for a time comprised of between 5 and 20 minutes so as to obtain a homogenous solution and taking care to keep the solution protected from exposure to solar or artificial light.

15. The method according to claim 14, wherein the step of preparing a solution further comprises adding from 10 to 60 parts of resin and from 40 to 90 parts of solvents or monomers; and
the step of adding at least one photoinitiator further comprises adding photoinitiators previously solubilised in solvents at 40-60%, and added to the solution in a percentage of 1-6%.

16. A polymerisation procedure for the chemical composition according to claim 1, comprising the steps of:
applying the chemical composition onto a substrate
applying UV-A, UV-B or UV-C irradiation for a time comprised of between 2 seconds and 15 minutes.

17. The procedure according to claim 16, wherein the step of applying UV-A irradiation further comprises the step of emitting radiation between 280 and 450 nm.

18. The procedure according to claim 17, wherein the step of emitting radiation further comprises emitting radiation with a fluorescence or metallic iodide type lamp.

19. The procedure according to claim 16, wherein the step of applying UV-B and UV-C irradiation further comprises that step of emitting irradiation with lamps equipped with special filters for the neutralisation of the B and C type radiation.

20. The procedure according to claim 16, wherein the step of applying irradiation further comprises using lamps with power outputs of between 100 W and 5 KW.

21. The procedure according to claim 16, wherein the step of applying irradiation further comprises using multi-lamp systems with variable power outputs from 200 W up to 5 KW per lamp unit.

22. The procedure according to claim 16, wherein the step of applying irradiation further comprises using one or more lamps with a power output that varies from 0.1 W/cm² to 20 W/cm².

23. The procedure according to claim 16, wherein the step of applying irradiation further comprises mounting UV emitting lamps onto robotised rigs which are able to irradiate complex profile surfaces in a homogeneous manner by carrying out a scan of the surface to be irradiated with a scanning speed directly proportional to the power output of the UV system used.

24. The procedure according to claim 23, wherein the step of applying irradiation further comprises using lamps with variable power outputs of between 2.5 KW to 25 KW.

25. The treatment method for bodywork or parts of the bodywork of vehicles, comprising the steps of:
i) providing a polymerisable chemical composition according to claim 1;
ii) applying a layer of said chemical composition onto the surfaces to be treated;
iii) leaving the solvent contained in said layer of said chemical composition to evaporate;
iv) irradiating said layer with a UV radiation lamp for a sufficient time so as to substantially obtain the complete polymerisation thereof.

26. The method according to claim 25, wherein the step of applying a layer of said chemical composition further comprises depositing in the form of a film previously diluted with an appropriate solvent, said film having a thickness which can vary between 10 microns to 100 microns and a viscosity which can vary between 12 to 18 seconds in a Ford #4 cup.

27. The method according to claim 25, wherein the step of leaving the solvent to evaporate comprises leaving the solvent to evaporate from 1 minute to 5 minutes.

28. The method according to claim 25, wherein the step of irradiating further comprises applying UV-A, UV-B or UV-C irradiation for a time comprised of between 2 seconds and 15 minutes.

29. The method according to claim 25, further comprising the steps prior to the application of the polymerisable chemical composition:
reshaping or replacing the damaged parts of the bodywork;
filling and sanding the surface of said damaged part;
applying one or more primers onto said surface and the relevant polymerisation;
preparing said surface for the application of “base coat” using abrasive papers;
applying the “base coat”.

30. The method according to claim 25, further comprising the step of finishing.

31. The use of a transparent, polymerisable chemical composition according to claim 1 for the treatment of bodywork or parts of the bodywork of vehicles.

32. The composition according to claim 4, wherein said resins have carboxylic functionality of between 2 and 6.

33. The composition according to claim 11, further comprising additives in quantities from 0.1% to 3%.
